(19) United States
(12) Patent Application Publication
(10) Pub. No.: US 2020/0308327 A1
(43) Pub. Date: Oct. 1, 2020

(54) Antistatic Material, Method for Manufacturing the Same, and Antistatic Method Using the Same

(71) Applicant: Boron Laboratory Co., Ltd., Chiba (JP)

(72) Inventor: Hiroyoshi HAMANAKA, Chiba (JP)

(21) Appl. No.: 16/831,629

(22) Filed: Mar. 26, 2020

(30) Foreign Application Priority Data
Mar. 28, 2019 (JP) 2019-064134

(51) Int. Cl. C08F 220/14; C09D 5/24; C09D 133/12

(52) U.S. Cl. CPC C08F 220/14; C08F 2800/20; C09D 133/12; C09D 5/24

(57) ABSTRACT

It is to provide an antistatic material that can maintain a high degree of electrostatic charge quenching performance over a long period without using an internally kneaded type antistatic agent, a method for manufacturing the same, and a method for preventing electrification using the same. An antistatic material of the present invention is that comprising an acrylic resin which is obtained by copolymerization of an acrylic monomer as an essential component including 70% by weight or more of methyl methacrylate and have in a main chain a structural unit of the following formula (1) having a side chain including a donor-acceptor molecular compound type atomic group consisting of non-ionic pair, in a proportion of 0.5 to 5% by weight based on a whole resin.

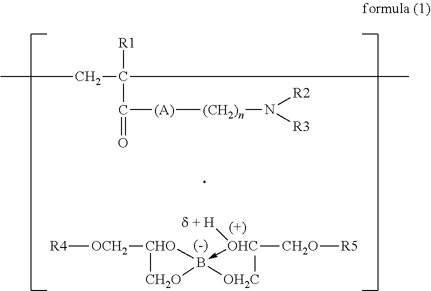

wherein R1 is H or CH₃, R2 and R3 each are an alkyl group having 1 to 3 carbon atoms, C₂H₄OH, or C₃H₇OH, R4 and R5 each are H or an acyl group having 12 to 22 carbon atoms, and at least one of R4 and R5 is an acyl group having 12 to 22 carbon atoms, A is O or NH, and n represents 2 or 3.

### TECHNICAL FIELD

The present invention relates to an antistatic material comprising an acrylic resin, a method for manufacturing the same, and a method for preventing electrification using the same.

### BACKGROUND ART

Currently, most plastic manufactured products that are manufactured in factories, appear on the market, and are used in various applications are insulators, have good characteristics in safety because they do not cause electrical shock phenomena to users and surrounding objects and are largely helpful at respective use sites.

However, since insulators also are easily electrified, when plastic manufactured products are continuously manufactured in a large amount, static electricity is generated to cause trouble, such that it may be necessary to stop the running of the manufacture apparatus or remaining static electricity may prevent the storage of the manufactured products.

Further, when a plastic manufactured product is an insulator, it may adsorb surrounding dust, dirt, and the like to significantly impair the appearance, and the electrified plastic manufactured product may disturb the normal operation of neighboring electronic equipment and give an electric shock to a person.

Accordingly, in order to overcome such problems, antistatic agents suitable for a variety of plastic manufactured products have been researched and developed.

The types of antistatic agents include a surface coating type antistatic agent with which a finished plastic manufactured product is treated to decrease the electrical resistivity of the surface portion of the manufactured product to a state where no electrification phenomenon is shown, and an internally kneaded type antistatic agent which is mixed with a plastic raw material to be molded. Because of the simplicity of the treatment method and superiority in performance sustaining power, the internally kneaded type antistatic agent is used in overwhelmingly many cases.

In addition, in terms of the mode of action, internally kneaded type antistatic agents are classified roughly into a surfactant type antistatic agent (non-patent document 1) and polymer type antistatic agent (non-patent document 2), wherein the surfactant type antistatic agent is distributed mainly on the surface in the process of mixing with a plastic raw material to be molded and decrease surface resistivity, and the polymer type antistatic agent decreases electrical resistivity as a polymer alloy in which both of main chains are compatibilized to be combined. And for each type and manufactured product of plastic, many compounds having different structures of internally kneaded type antistatic agents are synthesized, and those whose performance can be confirmed are used at manufacturing sites.

However, the polar internally kneaded type antistatic agent which has the mode of action in which electrostatic property is reduced with the formation of an impurity level cannot sufficiently support the prevention from a malfunction and disruption of electronic industrial equipment that has extended suddenly since the beginning of this century.

Accordingly, in recent years, the present inventor has developed an internally kneaded type antistatic agent having a new mode of action which can instantaneously neutralize and quench both positive electrostatic charge and negative electrostatic charge by making a state in which a donor-acceptor molecular compound that is a specific bonded body of particular nonionic substances to each other is homogeneously present in a small amount in the matrices of various types of plastic raw material and forming an ion pair type with a structural transformation simultaneously at the generation of electrostatic charge (non-patent documents 3 and 4).

The donor-acceptor molecular compound type internally kneaded type antistatic agent has characteristics that it can provide antistatic function to a wider range of various plastic raw materials than known surfactant type antistatic agents and polymer type antistatic agents, because it can be dispersed stably in the interior of a matrix by van der Waals force acting between it and the methylene group in main chain of a plastic raw material. Moreover, while being nonionic type organic material entirely different from electrically conductive materials such as an ionic liquid, a metal powder, and electrically conductive carbon, it can quickly and reliably completely leak to 0 V forced electrostatic charge forcedly produced on a plastic surface by applying a high voltage of 5000 to 10000 V, which causes static electricity hindrance, far beyond the performance level of conventional internally kneaded type antistatic agents (non-patent document 5).

The above internally kneaded type antistatic agent having a new mode of action consisting of a donor-acceptor molecular compound can be applied to many types of plastic manufactured products made of polyethylene terephthalate, polybutylene terephthalate, 6 nylon, 6-6 nylon, 12 nylon, a polyurethane and the like, to say nothing of polyolefins such as polyethylene and polypropylene, synthetic rubbers such as SBR and NBR, a vinyl chloride resin, poly(vinylidene 2-fluoride), EPDM, and the like, to contributes to the provision of manufactured products for which complete measures against static electricity are taken, because it is compatibilized with many types of plastic materials and dispersed in the interior as small particles to create charge transfer sites, unlike conventional antistatic agents.

Further, the present inventor has got a patent right for an internally kneaded type antistatic agent consisting of a donor-acceptor molecular compound that can be applied to IC equipment in which malfunction and disruption are caused by a very small amount of static electricity, and can more reliably prevent electrification of an insulator polymer material with good reproducibility and with sustainability (patent document 1).

But the above internally kneaded type antistatic agent consisting of a donor-acceptor molecular compound cannot provide a sufficient antistatic performance to an acrylic type resin having a side chain of ester group with methylene group in a main chain, because it is dispersed in a state solidified after being melt-dispersed in a micelle state, not in normal state and cannot effectively make charge transfer sites in the acrylic resin.

### PRIOR ART DOCUMENTS

### Patent Document

[Patent Document 1] Japanese Patent No. 5734491

### Non-Patent Documents

[Non-patent Document 1] Shinya Goto, Yasunori Hosokawa, CMC Technical Library 294, “Kaimenkasseizaigata Taidenboshizai (Surfactant Type Antistatic Agents),” p. 9 (2003)
[Non-patent Document 2] Hiroshi Sagane, CMC Technical Library 294, “Kobunshikei Jizokusei Taidenboshizai (Macromolecular Sustainable Antistatic Agents),” p. 40 (2003)
[Non-patent Document 3] Hiroyoshi Hamanaka, Plastics Age, “Dona-akuseputakei Bunshikagobutsugata Taidenboshizai no Seizo to Seino no Kakunin (Production of Donor-Acceptor Molecular Compound Type Antistatic Agent and Confirmation of Its Performance) (Jo (Part 1)),” p. 91 (2015)
[Non-patent Document 4] Hiroyoshi Hamanaka, Plastics Age, “Dona-akuseputakei Bunshikagobutsugata Taidenboshizai no Seizo to Seino no Kakunin (Production of Donor-Acceptor Molecular Compound Type Antistatic Agent and Confirmation of Its Performance) (Ge (Part 2)),” p. 85 (2015)
[Non-patent Document 5] Hiroyoshi Hamanaka, Plastics Age, “Shinkaihatsu no Dona-akuseputakei Bunshikagobutsugata Taidenboshizai no Oyotenkai (Application and Evolution of Newly Developed Donor-Acceptor Molecular Compound Type Antistatic Agent),” p. 47 (2018)
[Non-patent Document 6] Hiroyoshi Hamanaka, Journal of Japan Oil Chemists' Society, Vol. 29 (No. 12), “Studies on Semipolar Organoboron Surfactants,” p. 893 (1980)

### SUMMARY OF THE INVENTION

### Object to be Solved by the Invention

Acrylic resins are used in a wide variety of fields such as commodities, electrical accessories, automobile parts, agricultural greenhouses, and aquariums because of non-crystalline and high transparency in many cases. But it is the present circumstances that resin surfaces are electrified to draw dust, dirt, and the like and significantly deteriorate the appearance because there is no internally kneaded type antistatic agent having good reproducibility and high performance for acrylic resins.

Therefore, it is expected to develop a novel antistatic technique having high performance and sustainability to even more enhance the utility value of acrylic resins.

Accordingly, a purpose of the present invention is to provide an antistatic material (non-internally kneaded type antistatic material) that can maintain a high electrostatic charge quenching performance over a long period without using an internally kneaded type antistatic agent, a method for manufacturing the same, and a method for preventing electrification using the same.

### Means to Solve the Object

As a result of diligent research, the present inventor has found out that the above object can be solved by introducing, into the main chain of an acrylic resin, a structural unit having a side chain including a donor-acceptor molecular compound type atomic group consisting of a nonionic pair of formula (1) described later.

In other words, the above object is solved by inventions of the following 1) to 3) (the present inventions 1 to 3).

1) An antistatic material comprising an acrylic resin, the resin obtained by copolymerization of an acrylic monomer comprising 70% by weight or more of methyl methacrylate as an essential component, and having, in a main chain, a structural unit having a side chain including a donor-acceptor molecular compound type atomic group consisting of a nonionic pair of the following formula (1),

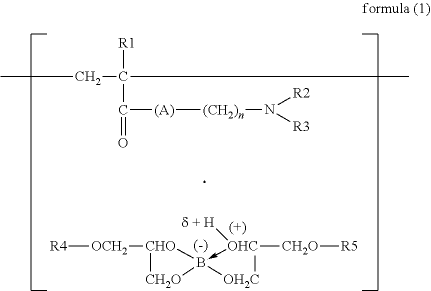

wherein R1 is H or CH₃, R2 and R3 each are an alkyl group having 1 to 3 carbon atoms, C₂H₄OH, or C₃H₇OH, R4 and R5 each are H or an acyl group having 12 to 22 carbon atoms, and at least one of R4 and R5 is an acyl group having 12 to 22 carbon atoms, A is O or NH, and n is 2 or 3,

in a proportion of 0.5 to 5% by weight based on a whole resin.

2) A method for manufacturing the antistatic material according to 1), comprising copolymerizing one or more acrylic monomers of the following formula (2) including 70% by weight or more of methyl methacrylate,

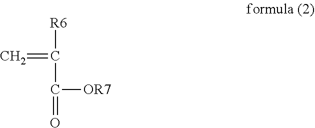

wherein R6 is H or CH₃, and R7 is an alkyl group having 1 to 4 carbon atoms,

and one or more donor-acceptor molecular compound monomers consisting of a nonionic pair of the following formula (3),

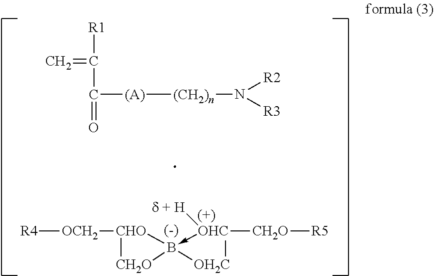

wherein R1 is H or CH₃, R2 and R3 each are an alkyl group having 1 to 3 carbon atoms, C₂H₄OH, or C₃H₇OH, R4 and R5 each are H or an acyl group having 12 to 22 carbon atoms, and at least one of R4 and R5 is an acyl group having 12 to 22 carbon atoms, A is O or NH, and n is 2 or 3,

with a proportion of the donor-acceptor molecular compound monomer being 0.5 to 5% by weight based on the whole monomer.

3) A method for manufacturing the antistatic material according to 1), comprising copolymerizing one or more acrylic monomers of the following formula (2) including 70% by weight or more of methyl methacrylate,

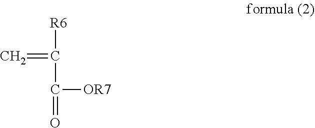

wherein R6 is H or CH₃, and R7 is an alkyl group having 1 to 4 carbon atoms,

and a basic nitrogen compound monomer of the following formula (4)

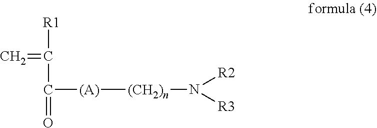

wherein R1 is H or CH₃, R2 and R3 each are an alkyl group having 1 to 3 carbon atoms, C₂H₄OH, or C₃H₇OH, A is O or NH, and n is 2 or 3

with a semipolar organoboron compound of the following formula (5)

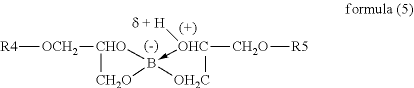

wherein R4 and R5 each are H or an acyl group having 12 to 22 carbon atoms, and at least one of R4 and R5 is an acyl group having 12 to 22 carbon atoms,

wherein the amount of the semipolar boron compound is equal to that of the basic nitrogen compound monomer and a proportion of a total amount of the basic nitrogen compound monomer and the semipolar organoboron compound is 0.5 to 5% by weight based on a whole material.

4) A method for preventing electrification of an article, comprising molding the antistatic material according to 1) into an article, or coating the article with the antistatic material according to 1).

### Effect of the Invention

According to the present invention, it is possible to provide an antistatic material (non-internally-kneaded type antistatic material) that can maintain a high degree of electrostatic charge quenching performance over a long period without using an internally kneaded type antistatic agent, a method for producing the same, and an method for preventing electrification using the same.

In addition, by the method for manufacturing of the present invention, the antistatic acrylic resin is not oxidatively colored, and maintain the transparency which is a feature of acrylic resins even after thermal polymerization, since the basic nitrogen compound and the semipolar organoboron compound constituting the donor-acceptor molecular compound type atomic group have a good compatibility with the acrylic type monomer and solvents used in some cases because of a nonionic pair, and also have a good heat resistance.

### MODE OF CARRYING OUT THE INVENTION

The present invention described above will be described in detail below.

A feature of the present invention 1 is that an acrylic resin has, in the main chain of the acrylic resin, a structural unit of formula (1) having a side chain including a donor-acceptor molecular compound type atomic group consisting of a nonionic pair, in the proportion of 0.5 to 5% by weight based on the whole resin. The atomic group relates to the basis of the performance exhibition mechanism of the antistatic material of the present invention and plays the important role of causing charge transfer transition to leak electrostatic charge. As a result, unlike conventional art in which electrification has been prevented by simply dispersing an internally kneaded type antistatic agent consisting of a donor-acceptor molecular compound into the matrices of various types of plastic manufactured products as an additive material, the acrylic resin have a high degree of electrostatic charge quenching performance over a long period and can continuously exhibit the antistatic effect, since charge leakage sites are reliably fixed in the acrylic resin itself.

In addition, the feature of the present invention is also that an acrylic monomer as a raw material monomer include 70% by weight or more of methyl methacrylate in order to ensure weather resistance and a high degree of transparency.

The acrylic resin used for the antistatic material of the present invention 1 can be manufactured by the same polymerization method as conventional one for acrylic resins except that one or more of the compounds used as starting raw materials have a specific structure for introducing the particular structural unit, as described later. Since The proportion of the particular structural unit formed in the obtained resin is roughly the same as that in the starting raw material, it is about 0.5 to 5% by weight based on the whole resin. In addition, the physical properties such as molecular weight and glass transition temperature, of the obtained resin may be the same as conventional ones, or rather it is desired that the physical properties of the obtained resin do not change much because a purpose of the present invention is to impart antistatic properties to a widely used acrylic resin. Although different depending on the application, many generally used acrylic resins have a weight average molecular weight of 10000 to 200000 and a glass transition temperature of about 80 to 120° C.

The antistatic material of the present invention 1 can be obtained by the method for manufacturing of the present invention 2 or 3.

In the present invention 2, a monomer of formula (3) having a donor-acceptor molecular compound type atomic group consisting of a nonionic pair is previously synthesized, and one or more thereof and one or more acrylic monomers of formula (2) are copolymerized. The blending proportion of the monomer of formula (3) also varies depending on the type, application, and the like of the acrylic resin used, but is about 0.5 to 5% by weight based on the amount of all monomers so that the structural unit of formula (1) can be present in the main chain at a suitable distance. The smaller proportion is not preferred since sufficient antistatic properties cannot be imparted, and the larger proportion is not preferred since there is a risk that the original physical properties of the acrylic resin vary.

In addition, the type of the acrylic monomer of formula (2) is not particularly limited in terms of the polymerization reaction, but in the present invention, methyl methacrylate alone or a mixture of another acrylic monomer with methyl methacrylate in the proportion of 30% by weight or less is used for the above-described reason.

In the present invention 3, instead of the donor-acceptor molecular compound monomer of formula (3) used in the present invention 2, of a mixture of a basic nitrogen compound monomer of formula (4) and a semipolar organoboron compound of formula (5) in substantially equimolar amounts (molar ratio: 0.9/1.1 to 1.1/0.9) are polymerized with the acrylic monomer of formula (2). Thus, the structural unit of formula (1) is formed in the main chain during the polymerization reaction. The basic nitrogen compound monomer of formula (4) and the semipolar organoboron compound of formula (5) react by the reaction heat accompanying the polymerization reaction, to form a donor-acceptor molecular compound type atomic group. The total mixture proportion of the compounds of formula (4) and formula (5) is about 0.5 to 5% by weight based on the whole of the materials for a reason similar to that in the case of the present invention 1 described above.

“δ+” in the semipolar organoboron compound in formula (1), (3), or (5) shows that polarity is present in a covalent bond within the molecule, (+) shows that the electron donating properties of the oxygen atom become strong, “→” shows a path in which an electron is attracted, and “ . . . ” shows a state in which the interatomic bonding force is weakened. The technical significance of the phenomenon related to these symbols will be described in paragraph 0021.

In the manufacturing of the antistatic material of the present invention, the method for polymerizing the acrylic monomer of formula (2) forming the main chain is similar to that in the case of known acrylic resins. A monomer casting method in which a raw material monomer component is placed in an exclusive manufacturing mold and polymerized, a solution polymerization method in which a raw material monomer component is polymerized in a state of being uniformly dissolved in a good solvent, an emulsion polymerization method in which a raw material monomer component is polymerized in a state of being stably dispersed in water using a surfactant, and the polymerization product is also controlled so as to be in a stably dispersed state, and the like can be applied as they are.

And in a process in which the acrylic monomer of formula (2) is polymerized by a radical, the structural unit of formula (1) is constructed in the main chain at suitable distribution by that the basic nitrogen compound of formula (4) having a vinyl group and a tertiary amino group, and/or the monomer having a donor-acceptor molecular compound type atomic group formed between the tertiary amino group at the end of a side chain of the basic nitrogen compound of formula (4) and the semipolar organoboron compound of formula (5) are smoothly copolymerized with the acrylic monomer to form a strong chemical bond.

Internally kneaded type antistatic agents are effective for electrification prevention measures to various resins, but few shows satisfactory performance for acrylic resins. For example, some acrylic resins have tried to be manufactured by copolymerization using a considerable amount of a vinyl-based monomer having an ionic group as a side chain for electrification prevention measures, but they were not suitable for a practical use because resins are thermally colored, and the physical properties of resins change greatly.

But by the method for manufacturing of the present invention 2 wherein the acrylic monomer of formula (2) forming the main chain is smoothly copolymerized with the donor-acceptor molecular compound monomer of general formula (3) added in an amount of about 0.5 to 5.0% by weight based on the whole of the monomers, an acrylic resin used for an antistatic material in which the structural unit of formula (1) is suitably distributed in the main chain can be obtained. And since the structural unit is chemically bonded at suitable distribution, the resin can semipermanently continue to have an effective electrostatic charge leakage function over a whole.

The reaction conditions of the present invention may also be similar to a general procedure for polymerization of an acrylic monomer including 70% by weight or more of methyl methacrylate wherein it polymerizes under atmospheric pressure in the temperature range of 60 to 90° C. using peroxide as a catalyst.

Further, in the method for manufacturing of the present invention 3, the basic nitrogen compound monomer of formula (4) is mixed and copolymerized with the acrylic monomer of formula (2), in such that the semipolar organoboron compound of formula (5) is separately mixed, wherein the basic nitrogen compounds and the semipolar organoboron compound correspond to the raw material of the donor-acceptor molecular compound monomer of formula (3). Since the temperature conditions agree with an appropriate temperature at which the polymerization reaction proceeds, wherein the temperature conditions are that under which the basic nitrogen compound monomer of formula (4) or a product in a state in which the basic nitrogen compound monomer of formula (4) and the acrylic monomer of formula (2) are copolymerized, smoothly form a molecular compound, the final product after the completion of the polymerization reaction is the same as in the case of the present invention 2.

In addition, advantages of the present inventions 2 and 3 are that since all of the raw materials used, the product of the polymerization reaction, and the product forming the molecular compound have extremely good thermal stability for being non-ionic compounds, the transparency of the obtained antistatic acrylic resin is not decreased, and no oxidative coloration occurs either.

The method for preventing electrification of an article in the present invention 4 is performed by molding the antistatic material of the present invention 1 into an article or coating an article with the antistatic material of the present invention 1.

“Molding the antistatic material of the present invention 1 into an article” means molding the antistatic material of the present invention 1 as a material into an article, using an usual method for molding a resin, such as extrusion, injection molding, or blow molding. In this case, the article may be a completed article or a member. When the article is a member, a case where the member is combined with another member to form a completed article is also included.

“Coating an article with the antistatic material of the present invention 1” means coating an article with the antistatic material of the present invention 1 to impart an antistatic function to the article without adding a large change to the shape of the article. The article in this case may be a completed article or a member. When the article is a member, a case where the member is combined with another member to form a completed article to impart an antistatic function to a part of the completed article is also included.

The place to be coated may be a portion where it is wished to impart an antistatic function, and may be the whole of the article or part thereof.

The coating method is not particularly limited, and examples of the coating method include a method of spraying a solution comprising the antistatic material of the present invention 1, a method of brushing a solution comprising the antistatic material of the present invention 1, a method using a roll coater, a curtain coater, a bar coater, and a method by gravure printing. When the article to be coated is in the form of a film, a sheet, a plate, or the like, examples of the coating method include a method of layering on an article by coextrusion using a T-die, a method of making a film using the antistatic material of the present invention 1, and laminating the film on an article, and a method of casting on an article.

Here, examples of compounds that can be used in the antistatic material of the present invention are shown, but the compounds are not limited to these.

First, as the acrylic monomer of formula (2), methyl methacrylate is preferred, but when it is necessary to adjust processability depending on the application, or when it is necessary to make improvements so as to have more appropriate physical properties, one or more methacrylate such as ethyl methacrylate, propyl methacrylate, isopropyl methacrylate, and butyl methacrylate, and one or more acrylates such as methyl acrylate, ethyl acrylate, propyl acrylate, isopropyl acrylate, and butyl acrylate may be used in the range of 30% by weight or less based on the whole of the monomers.

In addition, examples of the basic nitrogen compound monomer of formula (4) include (2-dimethylaminoethyl) methacrylate, (3-dimethylaminopropyl) methacrylate, (2-diethylaminoethyl) methacrylate, (3-diethylaminopropyl) methacrylate, (3-dipropylaminopropyl) methacrylate, [2-{bis(2-hydroxyethyl)amino}ethyl] methacrylate, [2-{bis(2-hydroxypropyl)amino}ethyl] methacrylate, [3-{bis(2-hydroxypropyl)amino}propyl] methacrylate, (2-dimethylaminoethyl) acrylate, (3-dimethylaminopropyl) acrylate, (2-diethylaminoethyl) acrylate, (3-dipropylaminopropyl) acrylate, [2-{bis(2-hydroxyethyl)amino}ethyl] acrylate, [2-{bis(2-hydroxypropyl)amino}ethyl] acrylate, [3-{bis(2-hydroxypropyl)amino}propyl] acrylate, N-(3-dimethylaminopropyl)methacrylamide, N-(3-diethylaminopropyl)methacrylamide, N-(3-dimethylaminopropyl)acrylamide, and N-(3-diethylaminopropyl)acrylamide.

The semipolar organoboron compound of formula (5) can be synthesized by a method of reacting 2 mol of glycerin consisting of adjacent hydroxy groups with 1 mol of boric acid to make a 2:1 type fully esterified product (triesterified product), or a method of making a 2:1 type fully esterified product (triesterified product) by transesterification in which 2 mol of glycerin is reacted with 1 mol of a boric acid triester of a lower alcohol, and subsequently reacting one to two alcoholic OH groups remaining in the product with a fatty acid or a fatty acid ester of a lower alcohol (having a saturated or unsaturated alkyl group or alkenyl group having 11 to 21 carbon atoms) to perform an esterification reaction or a transesterification reaction. The temperature of a series of these reactions is suitably 50 to 250° C. at atmospheric pressure, and it is not particularly necessary to use a catalyst.

Further, as another method, 2 mol of a glycerin mono-fatty acid ester, an intermediate raw material, previously prepared may be reacted with 1 mol of boric acid or a boric acid triester of a lower alcohol to synthesize a 2:1 type boric acid fully esterified product (triesterified product). The reaction temperature in the case is suitably 100 to 200° C. at atmospheric pressure, and it is not particularly necessary to use a catalyst.

The meanings of the symbols in the semipolar organoboron compound in formula (1), (3), or (5) have been described in paragraph 0014, and non-patent document 5 explains an inherent phenomenon in which in a boron compound obtained by esterifying, with a fatty acid, one to two remaining OH groups in a boric acid fully esterified product (triesterified product) synthesized by the esterification reaction or transesterification reaction of 2 mol of glycerin and 1 mol of boric acid or a boric acid triester of a lower alcohol, the electrostatic charge is transferred and transitioned by the activation of the electron behavior within the molecule. In addition, it is reported by the present inventor at the stage of basic research and recognized that the energy state of the alcoholic OH group in the vicinity of the boron atom that enables to cause the phenomenon shows the formation of the semipolar bond of the OH group according to the out-of-plane bending vibration of the OH group (see the following [Formula 7]) significantly seen at 830 to 840 cm⁻¹ (see non-patent document 6).

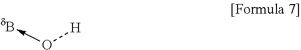

Next, specific examples of the semipolar organoboron compound used in the present invention will be shown, but the semipolar organoboron compound is not limited to these. In addition, a compound of formula 8 is expressed with a convenient device because the whole structure does not fit within the range of the width of the page, and the actual structure of the central part is the same as that of other illustrated compounds.

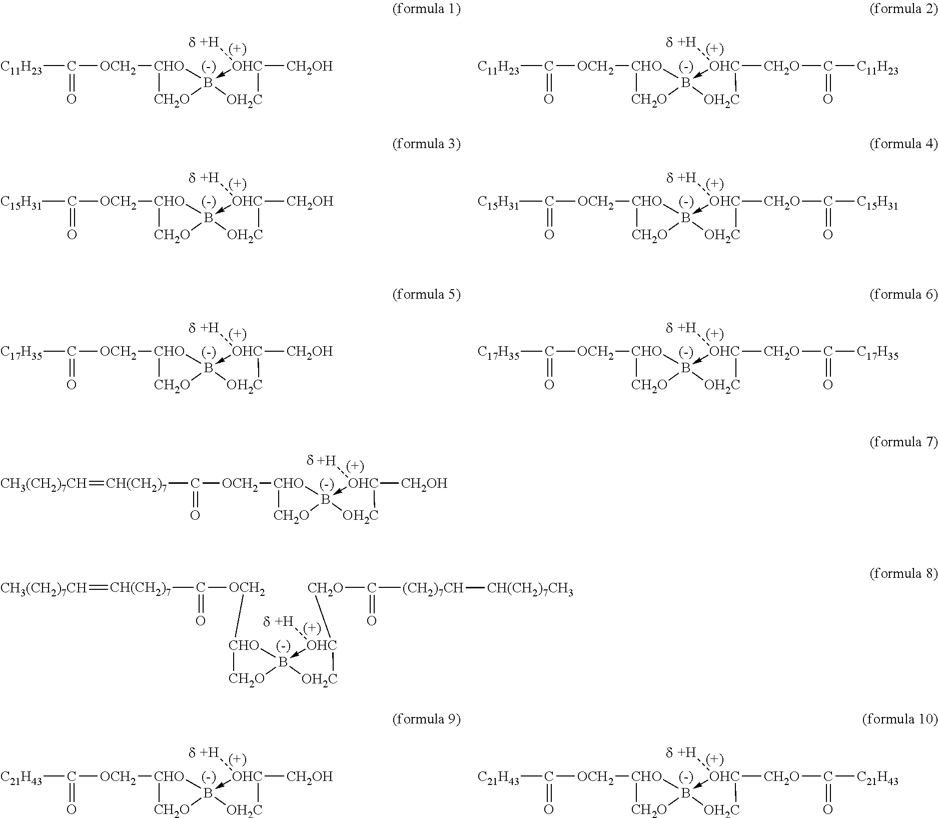

### EXAMPLES

The present invention will be further specifically described below by giving Examples and Comparative Examples, but the present invention is not limited to these Examples. “Parts” and “%” in the examples are “parts by weight” and “% by weight” unless otherwise noted.

### Example 1

A mixed solution obtained by dissolving 2% of a molecular compound consisting of [2-(dimethylamino)ethyl] methacrylate and the semipolar organoboron compound of (formula 6) in 100 parts of methyl methacrylate was inserted between two pressure-resistant glass plates frame-fastened with a 2 mm thick silicone rubber at 60° C., and 0.5 parts of azobis(isobutyronitrile) was added. Subsequently, the mixture between the glass plates was allowed to stand in a constant humidity tank set at 60° C. for 15 h to perform monomer casting molding. Then, the reaction product was taken out and cooled to room temperature, and subsequently the glass plates were taken off to manufacture a 2 mm thick colorless transparent uniform antistatic acrylic resin plate.

### Example 2

A mixed solution obtained by dissolving 0.5% of a molecular compound consisting of [2-{bis(2-hydroxypropyl)amino}ethyl] methacrylate and the semipolar organoboron compound of (formula 1) in a mixture of 90 parts of methyl methacrylate and 10 parts of isopropyl methacrylate was inserted between two pressure-resistant glass plates frame-fastened with a 2 mm thick silicone rubber, and 0.3 parts of azobis(isobutyronitrile) was added. Subsequently, the mixture between the glass plates was allowed to stand in a constant temperature tank set at 60° C. for 8 h to perform monomer casting molding. Then, an operation similar to that in Example 1 was performed to manufacture a 2 mm thick colorless transparent uniform antistatic acrylic resin plate.

### Example 3

A mixed solution obtained by dissolving 5% of a molecular compound consisting of (2-dimethylaminoethyl) methacrylate and the semipolar organoboron compound of (formula 10) in a mixture of 70 parts of methyl methacrylate, 25 parts of ethyl methacrylate, and 5 parts of methyl acrylate was inserted between two pressure-resistant glass plates frame-fastened with a 2 mm thick silicone rubber, and 0.6 parts of azobis(isobutyronitrile) was added. Subsequently, the mixture between the glass plates was allowed to stand in a constant temperature tank set at 90° C. for 15 h to perform monomer casting molding. Then, an operation similar to that in Example 1 was performed to manufacture a 2 mm thick colorless transparent uniform antistatic acrylic resin plate.

### Example 4

A mixed solution obtained by dissolving 2% of a molecular compound consisting of (2-diethylaminoethyl) methacrylate and the semipolar organoboron compound of (formula 4) and 0.5% of a molecular compound consisting of N-(3-dimethylaminopropyl)acrylamide and the semipolar organoboron compound of (formula 8) in a mixture of 90 parts of methyl methacrylate, 5 parts of ethyl methacrylate, and 5 parts of ethyl acrylate was inserted between two pressure-resistant glass plates frame-fastened with a 2 mm thick silicone rubber, and 0.5 parts of azobis(isobutyronitrile) was added. Subsequently, the mixture between the glass plates was allowed to stand in a constant temperature tank set at 65° C. for 15 h to perform monomer casting molding. Then, an operation similar to that in Example 1 was performed to manufacture a 2 mm thick colorless transparent uniform antistatic acrylic resin plate.

### Example 5

A mixed solution obtained by dissolving 3% of a molecular compound consisting of (2-dimethylaminoethyl) methacrylate and the semipolar organoboron compound of (formula 7) and 2% of a molecular compound consisting of N-(3-diethylaminopropyl)acrylamide and the semipolar organoboron compound of (formula 9) in a mixture of 80 parts of methyl methacrylate, 10 parts of butyl methacrylate, and 10 parts of methyl acrylate was inserted between two pressure-resistant glass plates frame-fastened with a 2 mm thick silicone rubber, and 0.5 parts of azobis(isobutyronitrile) was added. Subsequently, the mixture between the glass plates was allowed to stand in a constant temperature tank set at 80° C. for 12 h to perform monomer casting molding. Then, an operation similar to that in Example 1 was performed to manufacture a 2 mm thick colorless transparent uniform antistatic acrylic resin plate.

### Example 6

0.15 parts of (2-dimethylaminoethyl) methacrylate, 0.35 parts of the semipolar organoboron compound of (formula 1), and 0.3 parts of azobis(isobutyronitrile) were separately added into 100 parts of methyl methacrylate between two pressure-resistant glass plates frame-fastened with a 2 mm thick silicone rubber, and subsequently they were maintained at 65° C. for 15 h in a state of being mutually dissolved, and further allowed to stand in a constant temperature tank set at 60 to 70° C. for 12 h to perform monomer casting molding. Then, an operation similar to that in Example 1 was performed to manufacture a 2 mm thick colorless transparent uniform antistatic acrylic resin plate.

### Example 7

1.7 parts of N-(3-diethylaminopropyl)methacrylamide, 3.4 parts of the semipolar organoboron compound of (formula 8), and 0.8 parts of azobis(isobutyronitrile) were separately added into a mixture of 90 parts of methyl methacrylate and 10 parts of methyl acrylate between two pressure-resistant glass plates frame-fastened with a 2 mm thick silicone rubber, and subsequently the mixture between the glass plates was allowed to stand in a constant temperature tank set at 70 to 80° C. for 10 h to perform monomer casting molding. Then, an operation similar to that in Example 1 was performed to manufacture a 2 mm thick colorless transparent uniform antistatic acrylic resin plate.

### Comparative Example 1

100 parts of methyl methacrylate, 10 parts of N-(3-dimethylaminopropyl)acrylamide, and 0.8 parts of azobis(isobutyronitrile) were added between two pressure-resistant glass plates frame-fastened with a 2 mm thick silicone rubber, and subsequently allowed to stand in a constant temperature tank set at 80° C. for 10 h to perform monomer casting molding. Then, an operation similar to that in Example 1 was performed to manufacture a 2 mm thick yellowish brown transparent acrylic resin plate.

### Comparative Example 2

100 parts of methyl methacrylate, 5 parts of the semipolar organoboron compound of (formula 6), and 0.8 parts of azobis(isobutyronitrile) were added between two pressure-resistant glass plates frame-fastened with a 2 mm thick silicone rubber, and subsequently allowed to stand in a constant temperature tank set at 80° C. for 10 h to perform monomer casting molding. Then, an operation similar to that in Example 1 was performed to manufacture a 2 mm thick colorless transparent acrylic resin plate.

For each of the acrylic resin plates of the above Examples 1 to 7 and Comparative Examples 1 and 2, the surface resistivity when the acrylic resin plate was allowed to stand under the conditions of 23° C. and 50% RH for 72 h and when the acrylic resin plate was stored under the conditions of 23° C. and 50% RH for 2 years, and the forced electrostatic charge decay half-life when a voltage of 10 kV was applied for 30 s to forcedly charge the acrylic resin plate and subsequently the application was released were measured.

On the other hand, each of the acrylic resin plates of the Examples and the Comparative Examples was placed in a beaker, contacted to water at 30° C. at a flow rate of 20 g/s for 3 h, and subsequently taken out and allowed to stand under the conditions of 23° C. and 50% RH for 72 h, and subsequently the surface resistivity was measured.

For the measurement of the forced electrostatic charge decay half-life, STATIC HONESTMETER manufactured by SHISHIDO ELECTROSTATIC, LTD. was used, and for the measurement of the surface resistivity, an ST-4 type surface resistance meter manufactured by SIMCO JAPAN and Hiresta manufactured by Mitsubishi Chemical Analytech Co., Ltd. were used.

The results are shown in Table 1, and it is found that the antistatic performance for Examples 1 to 7 is extremely excellent, and is unlikely to change even when the measurement conditions vary, and a high degree of electrostatic charge quenching performance can be maintained over a long period. This is due to the fact that a structural unit having a side chain including a donor-acceptor molecular compound type atomic group consisting of a nonionic pair of formula (1) is suitably introduced into an acrylic resin.

For a transparent acrylic resin plate manufactured by a monomer casting molding method without the addition of an antistatic agent using an acrylate-based monomer comprising 70% by weight or more of methyl methacrylate as a starting raw material, the surface resistivity under the conditions of 23° C. and 50% RH is 5.0×10¹⁵Ω/□, and the natural decay of forced electrostatic charge is about 20% even when 3 min elapses.

TABLE 1

| | Surface resistivity (Ω/□) | | Forced electrostatic charge | |
|---|---|---|---|---|
| | (23° C., 50% RH) | | decay half-life (s) after | Surface resistivity (Ω/□) |
| | After standing | After standing | application of 10 kV for 30 | (23° C., 50% RH) after |
| Specimen | for 72 h | for 2 years | s | flowing water contact for 3 h |
| Manufactured | 7.1 × 10⁹ | 7.1 × 10⁹ | 0.13 | 6.9 × 10⁹ |
| product of Example 1 | | | | |
| Manufactured | 6.3 × 10¹⁰ | 6.2 × 10¹⁰ | 0.20 | 6.2 × 10¹⁰ |
| product of Example 2 | | | | |
| Manufactured | 5.3 × 10¹⁰ | 5.3 × 10¹⁰ | 0.18 | 5.3 × 10¹⁰ |
| product of Example 3 | | | | |
| Manufactured | 1.0 × 10¹⁰ | 1.2 × 10¹⁰ | 0.17 | 1.2 × 10¹⁰ |
| product of Example 4 | | | | |
| Manufactured | 2.0 × 10¹⁰ | 1.8 × 10¹⁰ | 0.18 | 1.8 × 10¹⁰ |
| product of Example 5 | | | | |
| Manufactured | 7.9 × 10¹⁰ | 7.9 × 10¹⁰ | 2.00 | 7.8 × 10¹⁰ |
| product of Example 6 | | | | |
| Manufactured | 1.3 × 10¹⁰ | 1.3 × 10¹⁰ | 0.18 | 1.3 × 10¹⁰ |
| product of Example 7 | | | | |
| Manufactured | 5.0 × 10¹³ | 4.7 × 10¹³ | 23.1 | 9.3 × 10¹³ |
| product of | | | | |
| Comparative | | | | |
| Example 1 | | | | |
| Manufactured | 7.9 × 10¹² | 7.9 × 10¹² | 18.0 | 1.3 × 10¹⁴ |
| product of | | | | |
| Comparative | | | | |
| Example 2 | | | | |

### Example 8

100 parts of methyl methacrylate, 2% of a molecular compound consisting of (3-diethylaminopropyl) methacrylate and the semipolar organoboron compound of (formula 6), and 250 parts of butyl acetate, a reaction solvent, were added to a sealed heating apparatus equipped with a rotary stirrer, a gas inflow tube, a cooling condenser, and a thermometer, and heated and mixed under a N₂ gas inflow. When the internal temperature reached 60° C., 0.3 parts of azobis(isobutyronitrile) was added. Then, the mixture was polymerized at 85 to 90° C. for 5 h to manufacture a colorless transparent antistatic acrylic resin solution.

In addition, the obtained acrylic resin solution was moved to a reduced pressure apparatus and subsequently gradually heated from 100° C. to 240° C. to remove the butyl acetate of the solvent. The obtained melt of the acrylic resin was subjected to an extrusion machine to manufacture a 22 cm×30 cm×1 mm thick sheet.

### Example 9

A mixture of 70 parts of methyl methacrylate and 30 parts of butyl acrylate, 2% of a molecular compound consisting of N-(3-diethylaminopropyl)acrylamide and the semipolar organoboron compound of (formula 4), 3% of a molecular compound consisting of (3-dibutylaminopropyl) acrylate and the semipolar organoboron compound of (formula 10), 400 parts of butyl acetate, a reaction solvent, and 0.5 parts of azobis(isobutyronitrile) were added to a sealed heating apparatus similar to that in Example 8 and polymerized at 90° C. for 10 h to manufacture a colorless transparent antistatic acrylic resin solution.

In addition, the solvent was removed from the obtained acrylic resin solution in a manner similar to that in Example 8, and the obtained melt of the acrylic resin was formed in the form of pellets having a diameter of 1.5 mm and a length of 2.0 mm by an extrusion machine. These were subjected to an injection molding machine at 230 to 240° C. to manufacture a 7 cm×10 cm×2 mm thick colorless transparent hard plate.

### Example 10

1% of (3-diethylaminopropyl) methacrylate, 2% of the semipolar organoboron compound of (formula 10), 300 parts of ethyl acetate, a reaction solvent, and 1 part of benzoyl peroxide were added to 100 parts of methyl methacrylate in a sealed heating apparatus similar to that in Example 8, and the mixture was polymerized at 80 to 90° C. for 12 h to manufacture a colorless transparent antistatic acrylic resin solution.

In addition, the solvent was removed under reduced pressure from the obtained acrylic resin solution, and the obtained melt of the acrylic resin was formed into pellets having a diameter of 1.5 mm and a length of 2.0 mm by an extrusion machine at 240° C. These were subjected to an injection molding machine at 235 to 245° C. to manufacture a 7 cm×10 cm×2 mm thick colorless transparent hard plate.

### Comparative Example 3

100 parts of methyl methacrylate, 5% of (3-diethylaminopropyl) methacrylate, 300 parts of butyl acetate, a reaction solvent, and 1 part of azobis(isobutyronitrile) were added to a sealed heating apparatus similar to that in Example 8 and polymerized at 85 to 90° C. for 5 h to manufacture a slightly yellow transparent acrylic resin solution.

In addition, the solvent was removed under reduced pressure from the obtained acrylic resin solution, and the obtained melt of the acrylic resin was formed into pellets having a diameter of 1.5 mm and a length of 2.0 mm by an extrusion machine. These were subjected to an injection molding machine at 230 to 240° C. to manufacture a 7 cm×10 cm×2 mm thick slightly yellow transparent hard plate.

### Comparative Example 4

100 parts of methyl methacrylate, 4% of the semipolar organoboron compound of (formula 6), 300 parts of butyl acetate, a reaction solvent, and 1 part of azobis(isobutyronitrile) were added to a sealed heating apparatus similar to that in Example 8 and polymerized at 85 to 90° C. for 5 h to manufacture a colorless transparent acrylic resin solution.

In addition, the solvent was removed under reduced pressure from the obtained acrylic resin solution, and the obtained melt of the acrylic resin was formed into pellets having a diameter of 1.5 mm and a length of 2.0 mm by an extrusion machine. These were subjected to an injection molding machine at 230 to 240° C. to manufacture a 7 cm×10 cm×2 mm thick colorless transparent hard plate.

Surfaces of 20 cm×30 cm×0.8 mm thick transparent sheets made of a methyl methacrylate resin containing no antistatic agent were coated with each of the acrylic resin solutions of the above Examples 8 to 10 and Comparative Examples 3 and 4 and subsequently hot air-treated at 80 to 90° C. for 10 min for solvent removal to manufacture a 5 μm thick homogeneous surface adhesive films.

Then, the surface resistivity when each of these surface adhesive films, and the sheet and the hard plates manufactured from the melts of the acrylic resins described above was allowed to stand under the conditions of 23° C. and 50% RH for 72 h and when each of the surface adhesive films, the sheet, and the hard plates was stored under the conditions of 23° C. and 50% RH for 2 years was measured. And a voltage of 10 kV was applied for 30 s to forcedly charge each of the surface adhesive films, the sheet, and the hard plates, and subsequently the application was released, and after 5 s, the electrostatic charge decay rate was measured.

Further, each of the surface adhesive films, sheet, and hard plates was immersed in warm water at 50° C. for 5 h and subsequently taken out and allowed to stand under the conditions of 23° C. and 50% RH for 72 h, and subsequently the surface resistivity was measured.

The equipment used for the measurement is the same as the case of Example 1.

The results are shown in Table 2, and it is found that the antistatic performance of the sheet and hard plates of the Examples is extremely excellent, and is unlikely to change even when the measurement conditions vary, and a high degree of electrostatic charge quenching performance can be maintained over a long period.

For the transparent methyl acrylate resin sheet without the addition of an antistatic agent before the surface adhesive film is attached, the surface resistivity under the conditions of 23° C. and 50% RH is 5.0×10¹⁵Ω/□, and the natural decay of forced electrostatic charge is about 20% even when 3 min elapses.

TABLE 2

| | | | | Electrostatic charge | Surface resistivity |
|---|---|---|---|---|---|
| | | Surface resistivity (Ω/□) | | decay rate (%) 5 s after | (Ω/□) (23° C., 50% |
| | | (23° C., 50% RH) | | application of 10 kV for | RH) after immersion |
| Measurement | | After standing | After standing | 30 s and release of | in water at 50° C. for |
| number | Specimen | for 72 h | for 2 years | application | 5 h |
| Example 8 | Surface | 8.7 × 10⁹ | 8.7 × 10⁹ | 100 | 8.6 × 10⁹ |
| | adhesive film | | | | |
| | Extruded | 6.3 × 10⁹ | 6.3 × 10⁹ | 100 | 6.3 × 10⁹ |
| | article | | | | |
| Example 9 | Surface | 4.0 × 10¹⁰ | 3.8 × 10¹⁰ | 100 | 3.9 × 10¹⁰ |
| | adhesive film | | | | |
| | Injection- | 4.0 × 10¹⁰ | 4.0 × 10¹⁰ | 100 | 4.0 × 10¹⁰ |
| | molded article | | | | |
| Example 10 | Surface | 9.5 × 10⁹ | 9.7 × 10⁹ | 100 | 9.6 × 10⁹ |
| | adhesive film | | | | |
| | Injection- | 7.9 × 10⁹ | 7.9 × 10⁹ | 100 | 7.9 × 10⁹ |
| | molded article | | | | |
| Comparative | Surface | 7.9 × 10¹³ | 6.8 × 10¹³ | 34 | 8.2 × 10¹³ |
| Example 3 | adhesive film | | | | |
| | Injection- | 6.3 × 10¹³ | 6.3 × 10¹³ | 37 | 7.8 × 10¹³ |
| | molded article | | | | |
| Comparative | Surface | 2.5 × 10¹³ | 7.5 × 10¹³ | 31 | 1.6 × 10¹⁴ |
| Example 4 | adhesive film | | | | |
| | Injection- | 3.8 × 10¹³ | 3.9 × 10¹³ | 34 | 3.2 × 10¹⁴ |
| | molded article | | | | |

### Example 11

90 parts of methyl methacrylate, 10 parts of isopropyl acrylate, 1% of a molecular compound consisting of (2-diethylaminoethyl) methacrylate and the semipolar organoboron compound of (formula 6), 1% of a molecular compound consisting of N-(3-dimethylaminopropyl)methacrylamide and the semipolar organoboron compound of (formula 8), 1.5 parts of poly(10 mol)oxyethylene lauryl ether as an emulsifier, and 250 parts of water, a solvent, were added to a sealed heating apparatus equipped with a rotary stirrer, a gas inflow tube, a cooling condenser, and a thermometer, and brought into an emulsified state under a N₂ gas inflow at 70 to 80° C., and subsequently 1 part of ammonium persulfate was added, and the mixture was reacted at the same temperature for 6 h to manufacture an emulsion polymer in the form of a white opaque liquid.

### Example 12

70 parts of methyl methacrylate, 30 parts of butyl methacrylate, 3 parts of (2-dibutylaminoethyl) acrylate, 2 parts of the semipolar organoboron compound of (formula 1), 2 parts of poly(10 mol)oxyethylene nonylphenyl ether as an emulsifier, and 250 parts of water, a solvent, were added to a sealed heating apparatus similar to that in Example 11, and 3 parts of a 30% hydrogen peroxide aqueous solution was added. The mixture was reacted under a N₂ gas inflow at 70 to 80° C. for 10 h to manufacture an emulsion polymer in the form of a white opaque liquid.

### Comparative Example 5

100 parts of methyl methacrylate, 5% of (2-dimethylaminoethyl) methacrylate, 1.5 parts of poly(10 mol)oxyethylene lauryl ether as an emulsifier, and 250 parts of water, a solvent, were added to a sealed heating apparatus similar to that in Example 11, and 1 part of ammonium persulfate was added. The mixture was reacted under a N₂ gas inflow at 70 to 80° C. for 6 h to manufacture an emulsion polymer in the form of a white opaque liquid.

### Comparative Example 6

70 parts of methyl methacrylate, 30 parts of butyl methacrylate, 5% of a molecular compound consisting of (2-stearoyloxyethyl)dimethylamine having no polymerization reactive group and the semipolar organoboron compound of (formula 6), 3 parts of poly(10 mol)oxyethylene nonylphenyl ether, an emulsifier, and 250 parts of water, a solvent, were added to a sealed heating apparatus similar to that in Example 11, and 1.5 parts of ammonium persulfate was added. The mixture was reacted under a N₂ gas inflow at 70 to 80° C. for 10 h to manufacture an emulsion polymer in the form of a white opaque liquid.

Surfaces of 10 cm×10 cm×1.5 mm thick transparent hard vinyl chloride resin plates containing no antistatic agent were coated with the emulsion polymers manufactured in the above Examples 11 and 12 and Comparative Examples 5 and 6, and subsequently hot air-treated at 90 to 100° C. for 10 min for dehydration to stick 5 μm thick surface adhesive films.

Then, the surface resistivity when each surface adhesive film was allowed to stand under the conditions of 23° C. and 50% RH for 72 h and when each surface adhesive film was stored under the conditions of 23° C. and 50% RH for 2 years was measured. And a voltage of 10 kV was applied for 30 s, and subsequently the application was released, and after 5 s, the electrostatic charge decay rate was measured. The equipment used for the measurement is the same as the case of Example 1.

Further, friction was repeated 20 times with a load of 300 g, and the presence or absence of the static electricity adsorption properties of a 4 mm×4 mm piece of paper laid directly below at a distance of 1 cm was observed.

The results are shown in Table 3, and the surface adhesive films of the Examples are excellent in adhesive strength and sustain good antistatic performance. In other words, it is found that even when the polymerization method is changed, the excellent antistatic acrylic resin according to the present invention is obtained.

For the transparent hard vinyl chloride resin plate containing no antistatic agent that is the object to be treated, the surface resistivity under the conditions of 23° C. and 50% RH is 6.3×10¹⁵Ω/□, the natural decay of forced electrostatic charge is unlikely to be seen even when 3 min elapses, and the friction charging properties are also extremely large.

TABLE 3

| | | | | Electrostatic charge | Adsorption properties |
|---|---|---|---|---|---|
| | | Surface resistivity (Ω/□) (23° C., | | decay rate (%) 5 s after | of piece of paper at |
| | | 50% RH) | | application of 10 kV for | distance of 1 cm after |
| Measurement | | After standing | After standing | 30 s and release of | 20 frictions with load |
| number | Specimen | for 72 h | for 2 years | application | of 300 g |
| Example 11 | Surface | 2.0 × 10¹⁰ | 2.0 × 10¹⁰ | 100 | Absent |
| | adhesive film | | | | |
| Example 12 | Surface | 4.1 × 10⁹ | 4.0 × 10⁹ | 100 | Absent |
| | adhesive film | | | | |
| Comparative | Surface | 6.3 × 10¹² | 7.0 × 10¹² | 25 | Absent |
| Example 5 | adhesive film | | | | |
| Comparative | Surface | 7.4 × 10¹² | 7.5 × 10¹² | 32 | Present |
| Example 6 | adhesive film | | | | |

### INDUSTRIAL APPLICABILITY

As described above, since acrylic resins have good weather resistance and are excellent in transparency, they are used in many fields such as commodities such as stationery and glasses, electrical accessories such as lighting fixtures, operation panels, and various types of displays, automobile parts such as tail lamps, meter covers, and indicator lamps, and large size manufactured objects such as agricultural greenhouses and large size tanks in aquariums, and further utilization in diverse applications is developed. But since there are no effective antistatic measures, a manufactured product equipped with antistatic performance is strongly desired to be provided.

Regarding this, the antistatic material of the present invention containing an acrylic resin has far better antistatic performance than prior art, it is industrially extremely useful owing to be able to contribute greatly to demand expansion and novel application development for acrylic resins.

1. An antistatic material comprising an acrylic resin, the resin obtained by copolymerization of an acrylic monomer comprising 70% by weight or more of methyl methacrylate as an essential component, and having, in a main chain, a structural unit having a side chain including a donor-acceptor molecular compound type atomic group consisting of a nonionic pair of the following formula (1), 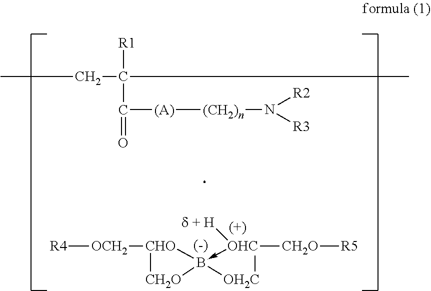
wherein R1 is H or CH₃, R2 and R3 each are an alkyl group having 1 to 3 carbon atoms, C₂H₄OH, or C₃H₇OH, R4 and R5 each are H or an acyl group having 12 to 22 carbon atoms, and at least one of R4 and R5 is an acyl group having 12 to 22 carbon atoms, A is O or NH, and n is 2 or 3,
in a proportion of 0.5 to 5% by weight based on a whole resin.

2. A method for manufacturing the antistatic material according to claim 1, comprising copolymerizing one or more acrylic monomers of the following formula (2) including 70% by weight or more of methyl methacrylate, 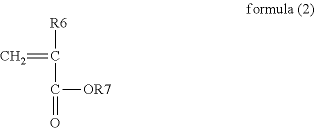
wherein R6 is H or CH₃, and R7 is an alkyl group having 1 to 4 carbon atoms,
and one or more donor-acceptor molecular compound monomers consisting of a nonionic pair of the following formula (3), 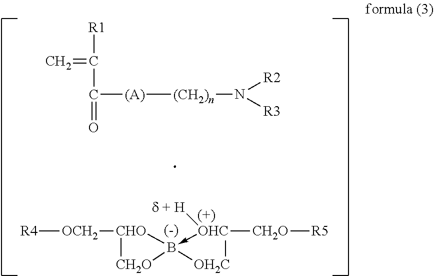
wherein R1 is H or CH₃, R2 and R3 each are an alkyl group having 1 to 3 carbon atoms, C₂H₄OH, or C₃H₇OH, R4 and R5 each are H or an acyl group having 12 to 22 carbon atoms, and at least one of R4 and R5 is an acyl group having 12 to 22 carbon atoms, A is O or NH, and n is 2 or 3,
with a proportion of the donor-acceptor molecular compound monomer being 0.5 to 5% by weight based on the whole monomer.

3. A method for manufacturing the antistatic material according to claim 1, comprising copolymerizing one or more acrylic monomers of the following formula (2) including 70% by weight or more of methyl methacrylate, 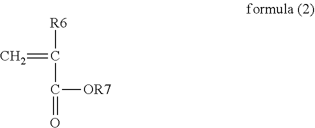
wherein R6 is H or CH₃, and R7 is an alkyl group having 1 to 4 carbon atoms,
and a basic nitrogen compound monomer of the following formula (4) 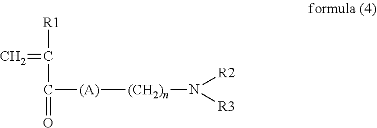
wherein R1 is H or CH₃, R2 and R3 each are an alkyl group having 1 to 3 carbon atoms, C₂H₄OH, or C₃H₇OH, A is O or NH, and n is 2 or 3,
with a semipolar organoboron compound of the following formula (5) 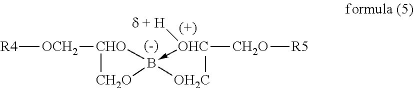
wherein R4 and R5 each are H or an acyl group having 12 to 22 carbon atoms, and at least one of R4 and R5 is an acyl group having 12 to 22 carbon atoms,
wherein the amount of the semipolar boron compound is equal to that of the basic nitrogen compound monomer, and a proportion of a total amount of the basic nitrogen compound monomer and the semipolar organoboron compound is 0.5 to 5% by weight based on a whole material.

4. A method for preventing electrification of an article, comprising molding the antistatic material according to claim 1 into an article, or coating the article with the antistatic material according to claim 1.
